(19) United States
(12) Patent Application Publication
(10) Pub. No.: US 2011/0180501 A1
(43) Pub. Date: Jul. 28, 2011

(54) DISASSEMBLABLE FOLDING CHAIR HANGING CART

(76) Inventors: Mei Chuen LIN, Taoyuan (TW); Tzu Mei Wang, Taoyuan (TW)

(21) Appl. No.: 12/695,349

(22) Filed: Jan. 28, 2010

(51) Int. Cl. B62B 3/10; A47F 7/30; A47B 81/00

(52) U.S. Cl. 211/85.8

(57) ABSTRACT

A disassemblable folding chair hanging cart is provided. The disassemblable folding chair hanging cart includes a chassis, two standing poles, two reinforcement sets, and a plurality of hanging racks. The chassis includes a plurality of caster sets distributed in different positions of the chassis for providing a stable support for the disassemblable folding chair hanging cart. The two standing poles are vertically and symmetrically erected on opposite positions of the chassis. Each reinforcement set is provided between one of the two standing poles and the chassis for reinforcing the connection strength therebetween. Each hanging rack includes a cross beam, and a plurality of hanging bars for hanging a plurality of folding chairs. The disassemblable folding chair hanging cart can be conveniently assembled from independent parts, and when an empty folding chair hanging cart is to be stored or delivered, it can be disassembled and packed in a minimum size.

### BACKGROUND OF THE INVENTION

1. Field of the Invention

The present invention relates generally to a hanging cart for carrying or storing multiple folding chairs, and more particularly, to a disassemblable folding chair hanging cart.

2. The Prior Arts

Conventionally, when folding chairs are exported, they usually have to be packaged in large corrugated cartons. These packaged folding chairs are adapted for exportation. However, after they are taken out and used, it is inconvenient to recollect them for storage. Accordingly, carts are used for carrying or storing the folding chairs. A typical cart used for carrying or storing folding chairs includes a chassis, and holding bars configured at two opposite sides of the chassis. Generally, folding chairs can be arranged in two ways on the cart. According to the first way, a first folding chair is leaned upon one of the holding bars at first, and then a second folding chair is leaned upon the first folding chair, and then a third folding chair is leaned upon the second, and so on until a last folding chair is leaned upon the another holding bar. The folding chairs accommodated on the cart are stably held between the two holding bars by pressing to each other. The second way is to place the folding chairs horizontally on the chassis and pile them up. The cart can accommodate several piles of the folding chairs. If the chassis has a large area, the cart can usually carry many folding chairs.

However, no matter which way to accommodate the folding chairs, the conventional cart does not have fence bars provided at rest sides of the chassis for securing the folding chairs carried thereon. When the cart is driven to move on a bumpy floor, the folding chairs may fall off from cart down to the floor due to vibration. Although the conventional cart can carry or store a lot of the folding chairs, it has to be carefully handled to prevent the folding chairs from falling off from the cart.

Further, the chassis and the holding bars are welded together, and when the cart is not in use, or an empty cart is to be delivered, the cart cannot be disassembled for storage or delivery, and therefore, such a cart occupies too much space.

### SUMMARY OF THE INVENTION

A primary objective of the present invention is to provide a folding chair hanging cart for overcoming the disadvantage of the conventional design that cannot effectively hold the folding chairs in place and preventing the folding chairs from falling off from the cart, so that the folding chairs won't be damaged and staff won't be injured by falling folding chairs.

Another objective of the present invention is to provide a disassemblable folding chair hanging cart. When an empty folding chair hanging cart is to be stored or delivered, it can be disassembled and packed in a minimum size.

For achieving the aforementioned objectives, the present invention provides a disassemblable folding chair hanging cart. The disassemblable folding chair hanging cart includes a chassis, two standing poles, two reinforcement sets, and a plurality of hanging racks. The chassis includes a plurality of caster sets distributed in different positions of the chassis for providing a stable support for the disassemblable folding chair hanging cart. The two standing poles are vertically and symmetrically erected on opposite positions of the chassis. Each of the two standing poles is configured with a plurality of assembly portions corresponding to that of the other. The assembly portions of each standing pole are configured at different heights and positions. Each reinforcement set is provided between one of the two standing poles and the chassis for reinforcing the connection strength therebetween. Each hanging rack includes a cross beam, and a plurality of hanging bars. Each cross beam has two opposite ends. The hanging bars of the hanging rack are perpendicularly crossover the cross beam. The opposite ends of each cross beam are correspondingly assembled with the assembly portions of the standing poles, so that the cross beams are assembled to the standing poles at different heights.

Both sides of the hanging bars are adapted for hanging up folding chairs. In operation, according to the size of the folding chairs to be hung, two or three immediately adjacent hanging bars are used for hanging one folding chair. In such a way, the disassemblable folding chair hanging cart can be used for carrying and delivering a plurality of folding chairs at the same time.

According to an aspect of the present invention, every part of the disassemblable folding chair hanging cart is adapted to be assembled and disassembled conveniently. Therefore, when the disassemblable folding chair hanging cart is going to be stored, it can be disassembled into independent parts, which are convenient for storage and delivery. When the disassemblable folding chair hanging cart is going to be used again, it can be reassembled conveniently.

According to a further aspect of the present invention, protective caps having extruded edges are provided at both ends of each hanging bar for interfering with the folding chair hanging thereon so as to prevent the folding chair from falling off therefrom.

### BRIEF DESCRIPTION OF THE DRAWINGS

The present invention will be apparent to those skilled in the art by reading the following detailed description of preferred embodiments thereof, with reference to the attached drawings, in which:

FIG. 1 is an exploded view showing the chassis according to an embodiment of the present invention;

FIG. 2 is an exploded view showing the chassis and standing poles according to an embodiment of the present invention;

FIG. 3 is an exploded view showing the standing poles and the reinforcement sets according to an embodiment of the present invention;

FIG. 4A is an exploded view showing the cross beam and the hanging bars of the hanging rack according to an embodiment of the present invention;

FIG. 4B is an exploded view showing the hanging bars and the protective caps according to an embodiment of the present invention;

FIG. 4C is a cross sectional view showing the hanging bars being secured to the cross beam by screw bolts according to an embodiment of the present invention;

FIG. 5 is an exploded view showing the standing poles and the hanging racks according to an embodiment of the present invention;

FIG. 6 illustrates the assembly of the disassemblable folding chair hanging cart;

FIG. 7 illustrates the operation status of the disassemblable folding chair hanging cart, in which a plurality of folding chairs are accommodated on the disassemblable folding chair hanging cart; and

FIG. 8 is a side view of operation status of FIG. 7.

### DETAILED DESCRIPTION OF THE PREFERRED EMBODIMENT

The accompanying drawings are included to provide a further understanding of the invention, and are incorporated in and constitute a part of this specification. The drawing illustrates embodiments of the invention and, together with the description, serves to explain the principles of the invention.

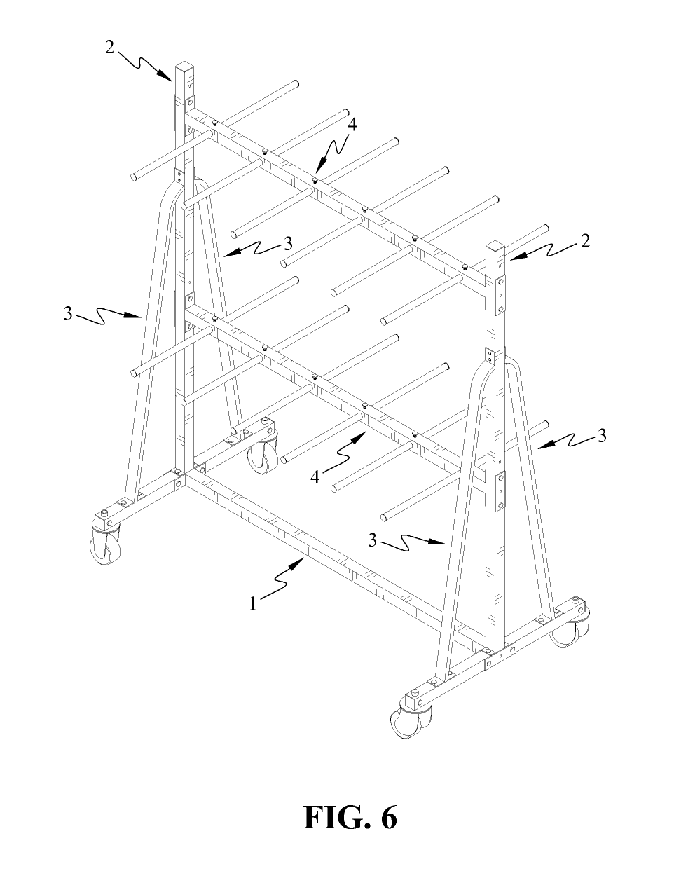

FIG. 6 illustrates the assembly of the disassemblable folding chair hanging cart. Referring to FIG. 6, the disassemblable folding chair hanging cart is mainly constituted of a plurality of stainless steel tube units, and generally includes a chassis 1, two standing poles 2, two reinforcement sets 3, a plurality of hanging racks 4, and a plurality of caster sets 6.

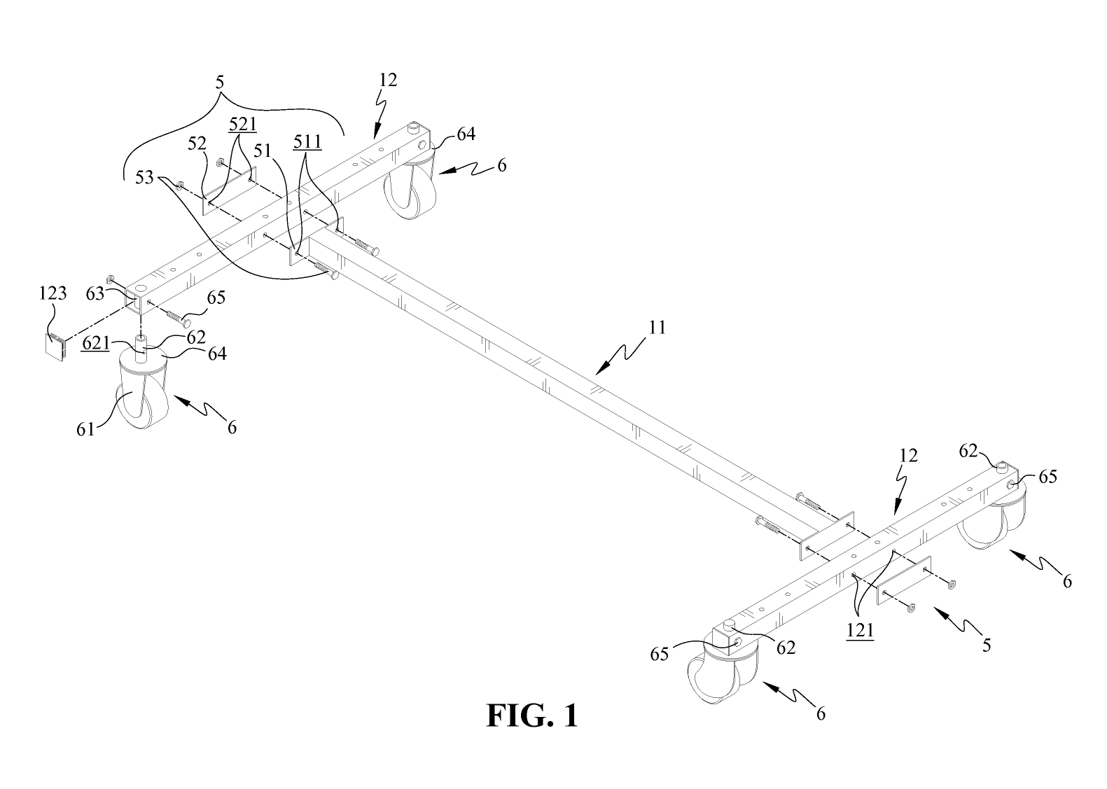

FIGS. 1 through 5 illustrate a step by step procedure of assembling the disassemblable folding chair hanging cart. However, all of the foregoing parts are designed for being assembled together for carrying or storing a plurality of folding chairs without specifically restricting the specific shapes or quantity of the tube units of each part.

FIG. 1 is an exploded view showing the chassis according to an embodiment of the present invention. Referring to FIG. 1, the chassis 1 includes a first primary rod 11 and two second primary rods 12. Preferably, the first primary rod 11 and the second primary rods 12 are made of square tubes. The first primary rod 11 is connected between the two second primary rods 12, thus configuring an “I” shaped architecture of the chassis 1. The first primary rod 11 is secured to each of the second primary rods 12 by a fastener unit 5. According to an aspect of the embodiment, the fastener unit 5 includes two side wing plates 51, a rectangular plate member 52, and two screw sets 53. The first primary rod 11 has two opposite end sides, and each of the two opposite end sides of the first primary rod 11 is connected to one of the two second primary rod 12 by such a fastener unit 5. The two side wing plates 51 of the fastener unit 5 are perpendicularly welded to the end side of the first primary rod 11. Each of the two side wing plates 51 is configured with a through hole 511. Corresponding to the through holes 511 of the two side wing plates 51, the second primary rod 12 to be connected to the end side is also configured with two through holes 121. Preferably, the inner walls of the through holes 121 are taped to configure inner threads thereby. Further, the rectangular plate member 52 is configured with two through holes 521 respectively corresponding to the through holes 511 of the two side wing plates 51. Each of the screw sets 53 includes a threaded bolt and a threaded nut. The threaded bolts of the screw sets 53 are adapted for sequentially passing through the through holes 511 of the side wing plates 51, passing through the through holes 121 while matching with the inner threads configured at the inner walls of the through holes 121, and then passing through the through holes 521 of the rectangular plate members 52, and finally being locked with the threaded nuts of the screw sets 53. In such a way, four fastener units 5 are used to secure the two second primary rods 12 to the two side ends of the first primary rod 11, thus configuring the “I” architecture of the chassis 1.

In accordance with a preferred embodiment of the present invention, both ends of each second primary rod 12 are provided with protective pads 123. The protective pads 123 are made of elastic or flexible materials, such as rubber. The protective pads 123 are adapted for protecting the user from being injured by the rigid end sides of the second primary rods 12. Further, the surface of each protective pad 123 is preferably configured with a protruded pattern for providing further protection to the protective pad 123 itself.

Further, the caster sets 6 are preferred to be swivel caster sets distributed in different positions of the chassis 1 for providing a stable support for the disassemblable folding chair hanging cart. In addition to a wheel, each caster set 6 includes at least one arm 61, a swivel-axle 62, a round hollow tube 63, and a gasket 64. The arm 61 is adapted for holding the wheel in place, and the swivel-axle 62 has a through hole 621 transversely configured through the swivel-axle 62. The round hollow tube 63 has a diameter slightly greater than that of the swivel-axle 62 and is erectly positioned inside an end of the second primary rod 12 for receiving the swivel-axle 62 therein. As shown in FIG. 1, both an upper surface and a bottom surface of the second primary rod 12 are configured with openings corresponding to two ends of the round hollow tube 63. The round hollow tube 63 is positioned such that the two ends of the round hollow tube 63 are aligned with the two openings of the second primary rod 12 at the upper surface and the bottom surface. A diameter of the openings is smaller than the diameter of the round hollow tube 63 and is slightly greater than the diameter of the swivel-axle 62.

Therefore, in assembling the caster set 6 to the second primary rod 12, the gasket 64 is sheathed over the swivel-axle 62. Then, the swivel-axle 62 is inserted into the round hollow tube 63 from the opening at the bottom surface of the second primary rod 12. Then, a threaded bolt 65 is passed from the second primary rod 12, through a side wall of the round hollow tube 63, and the through hole 621 of the swivel-axle 62 to the other side of the primary rod 12, and a corresponding threaded nut is used to lock the threaded bolt 65.

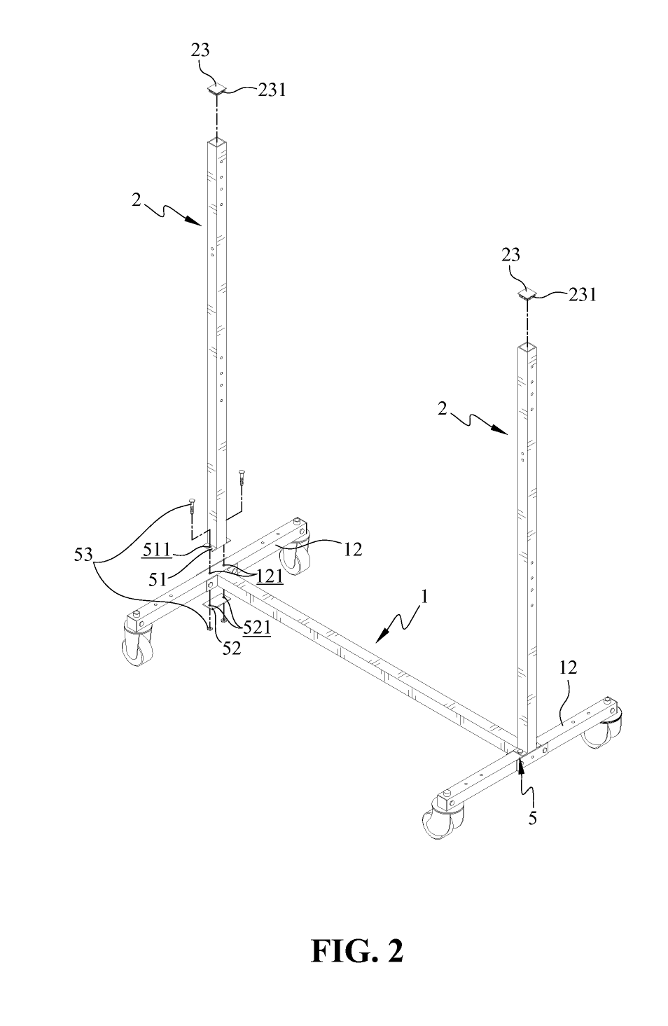

FIG. 2 is an exploded view showing the chassis and standing poles according to an embodiment of the present invention. Preferably, the standing poles 2 are made of square tubes. As shown in FIG. 2, the standing poles 2 are uprightly secured to the chassis 1 perpendicular to the first primary rod 11 and the second primary rods 12. Specifically, each standing pole 2 is secured to a corresponding second primary rod 12 by a fastener unit 5 as shown in FIG. 2. According to an aspect of the embodiment, the fastener unit 5 includes two side wing plates 51, a rectangular plate member 52, and two screw sets 53. Each of the standing poles 2 has a bottom side and a top side. The two side wing plates 51 of the fastener unit 5 are perpendicularly welded to a bottom side of the standing pole 2. Each of the two side wing plates 51 is configured with a through hole 511. Corresponding to the through holes 511 of the two side wing plates 51, the second primary rod 12 to be connected to the bottom side of the standing pole 2 is also configured with two through holes 121. Preferably, the inner walls of the through holes 121 are taped to configure inner threads thereby. Further, the rectangular plate member 52 is configured with two through holes 521 respectively corresponding to the through holes 511 of the two side wing plates 51. Each of the screw sets 53 includes a threaded bolt and a threaded nut. The threaded bolts of the screw sets 53 are adapted for sequentially passing through the through holes 511 of the side wing plates 51, passing through the through holes 121 while matching with the inner threads configured at the inner walls of the through holes 121, and then passing through the through holes 521 of the rectangular plate members 52, and finally being locked with the threaded nuts of the screw sets 53. In such a way, the two standing poles 2 are symmetrically assembled onto the chassis 1.

In accordance with a preferred embodiment of the present invention, the top sides of the standing poles 2 are provided with protective pads 23. The protective pads 23 are made of elastic or flexible materials, such as rubber. The protective pads 23 are adapted for protecting the user from being injured by the rigid top sides of the standing poles 2. Further, the surface of each protective pad 23 is preferably configured with a protruded pattern for providing further protection to the protective pad 23 itself.

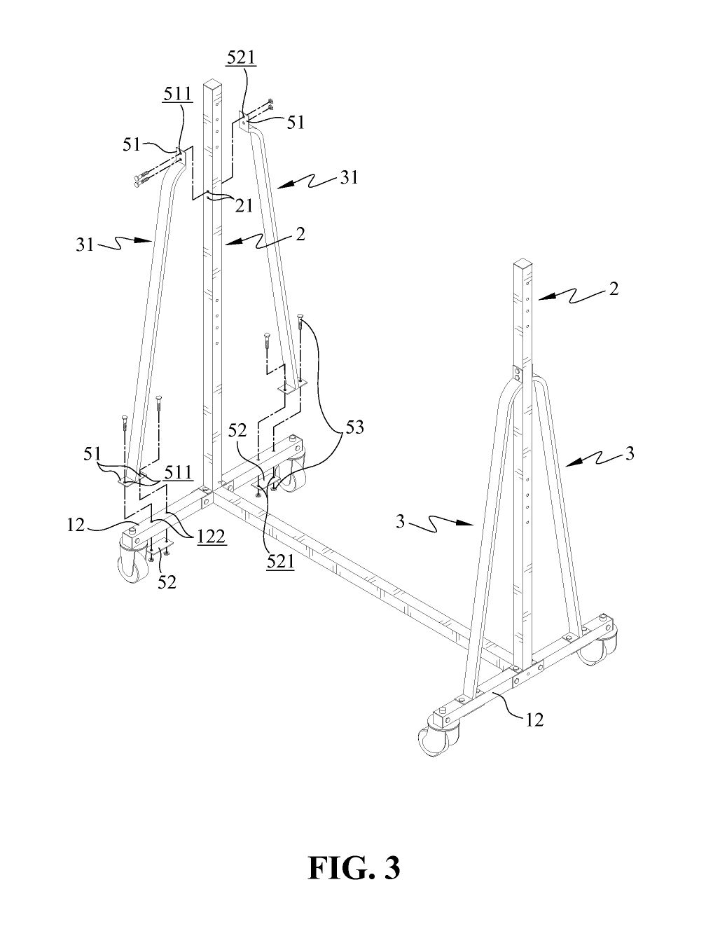

FIG. 3 is an exploded view showing the standing poles 2 and the reinforcement sets 3 according to an embodiment of the present invention. Referring to FIG. 3, each of the reinforcement sets 3 includes two identical reinforcement rods 31. Each reinforcement set 3 is connected between a standing pole 2 and a second primary rod 12 for reinforcing the strength of the connection between the standing pole 2 and the second primary rod 12. Specifically, the two reinforcement rods 31 of the reinforcement set 3 are symmetrically distributed at both sides of the standing pole 2 for connecting with two opposite sides of the second primary rod 12. Generally, the two reinforcement rods 31 of the reinforcement set 3 obliquely pull the standing pole 2 toward two opposite sides of the second primary rod 12, thus providing a reinforcement of the strength of the connection therebetween.

As shown in FIG. 3, a fastener unit 5 is provided for fastening an upper end of each of the two reinforcement rods 31 to one side surface of the standing pole 2, and another fastener unit 5 is provided for fastening a bottom end of the reinforcement rod 31 to the upper surface of the second primary rod 12. With respect to the fastener unit 5 fastening the upper end of the reinforcement rod 31 to the standing pole 2, it includes at least one side wing plate 51 welded to the upper end of the reinforcement rod 31 and parallel with the side surface of the standing pole 2. The at least one side wing plate 51 is configured with at least one through hole 511. At a corresponding position of the standing pole 2, there is configured at least one through hole 21 transversely extending through the standing pole 2. Preferably, the inner walls of the through holes 21 are taped to configure inner threads thereby. Similarly and symmetrically, the upper end of another reinforcement rod 31 of the reinforcement set 3 is connected to another side surface of the standing pole 2 by another fastener unit 5. Specifically, this fastener unit 5 also includes at least one side wing plates 51 welded to the upper end of the corresponding reinforcement rod 31 and parallel with the side surface of the standing pole 2, and this at least one side wing plate 51 is configured with at least one through hole 511. In assembling operation, the through holes 511 of the side wing plates 51 extending from the upper ends of both of the reinforcement rods 31 of the reinforcement set 3 are aligned with the through hole correspondingly configured on the standing pole 2. A screw set 53 including a threaded bolt and a threaded nut is provided for fastening the upper ends of the reinforcement rods 31 and the standing pole 2, in which the threaded bolt is sequentially inserted through the through hole of the side wing plate 51 of the upper end of one reinforcement rod 31, the through hole of the standing pole 2, and the through hole of the side wing plate 51 of the upper end of the other reinforcement rod 31, and is finally locked by the threaded nut at the opposite side of the standing pole 2. When extending through the through hole 21, the threaded bolt threadly matches with the threaded inner wall of the through hole 21.

As shown in FIG. 3, with respect to the fastener unit 5 provided for fastening a bottom end of the reinforcement rod 31 to the upper surface of the second primary rod 12, it includes a includes two side wing plates 51, a rectangular plate member 52, and two screw sets 53. The two side wing plates 51 of the fastener unit 5 are welded to the bottom end of the reinforcement rod 31. Each of the two side wing plates 51 is configured with a through hole 511. Corresponding to the through holes 511 of the two side wing plates 51, the first primary rod 11 to be connected to the bottom end of the reinforcement rod 31 is also configured with two through holes 122. Preferably, the inner walls of the through holes 122 are taped to configure inner threads thereby. Further, the rectangular plate member 52 is configured with two through holes 521 respectively corresponding to the through holes 511 of the two side wing plates 51. Each of the screw sets 53 includes a threaded bolt and a threaded nut. The threaded bolts of the screw sets 53 are adapted for sequentially passing through the through holes 511 of the side wing plates 51, passing through the through holes 122 while matching with the inner threads configured at the inner walls of the through holes 122, and then passing through the through holes 521 of the rectangular plate members 52, and finally being locked with the threaded nuts of the screw sets 53. In such a way, two fastener units 5 are used to secure the bottom end of the reinforcement rod 31 to one side of the second primary rod 12. In a similar manner, the bottom end of the other one reinforcement rod 31 of the reinforcement set 3 is secured to the other side of the second primary rod 12 by another two fastener unit 5. Likewise, another reinforcement set 3 is assembled for reinforcing the strength of connection between the other standing pole 2 and the other second primary rod 12, details of which can be learnt by referring to the above depiction and are not to be iterated hereby.

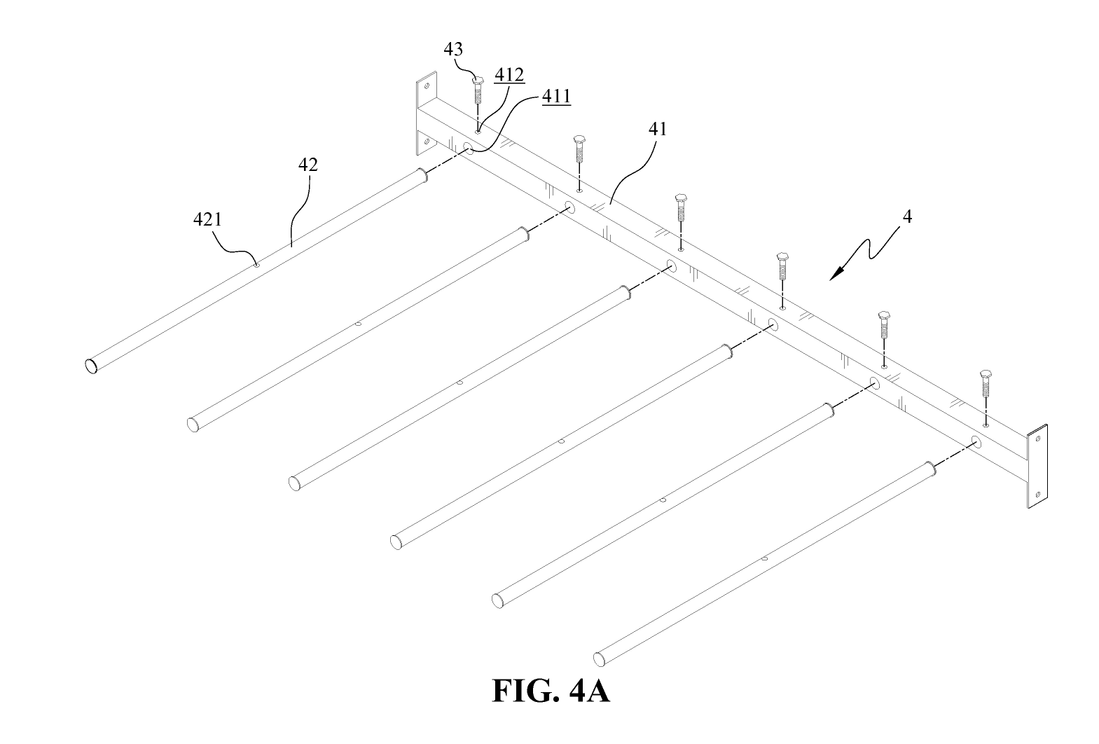

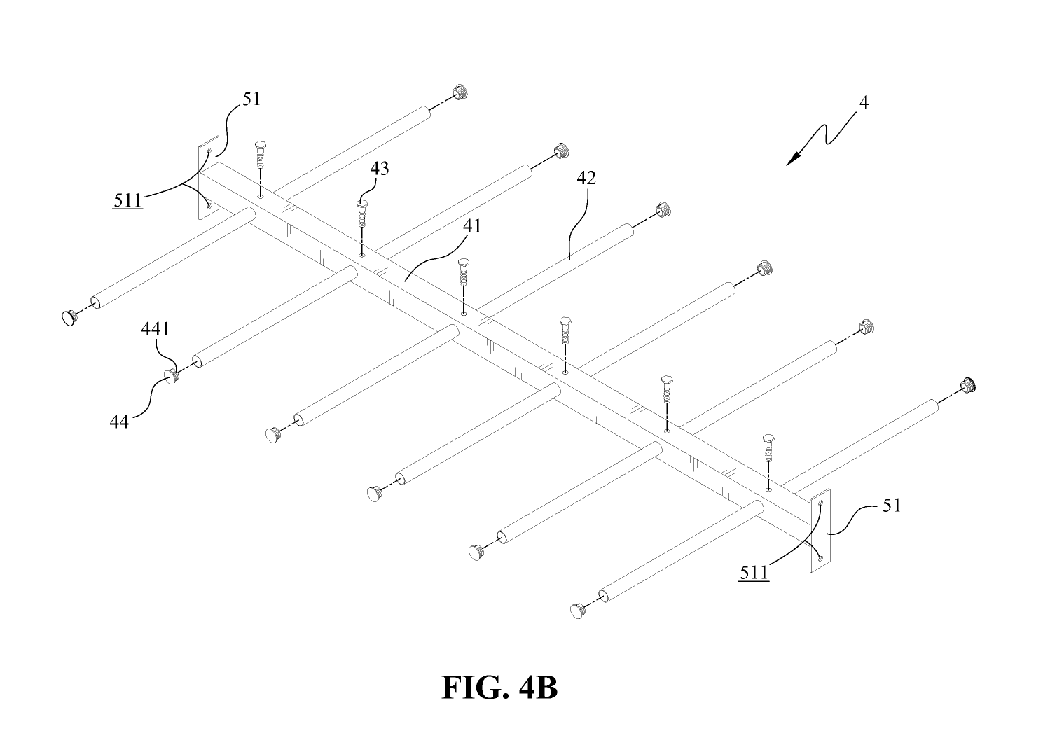

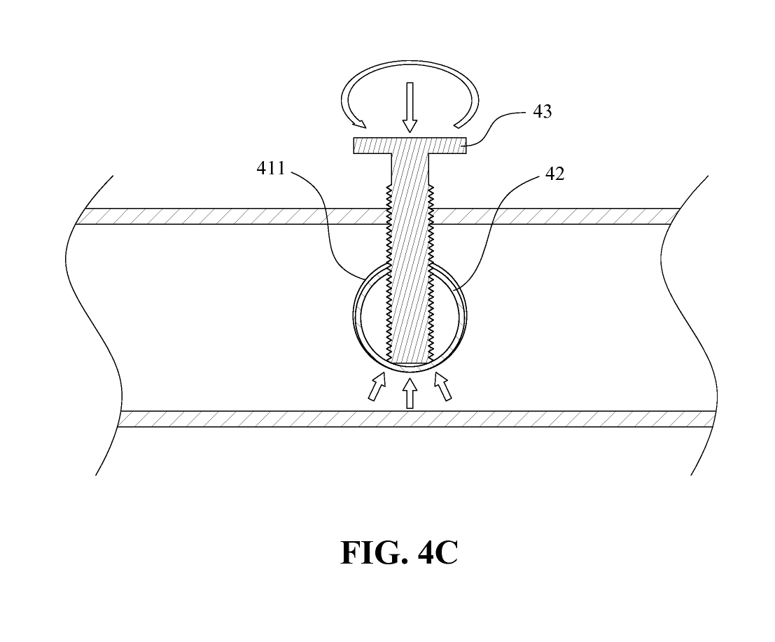

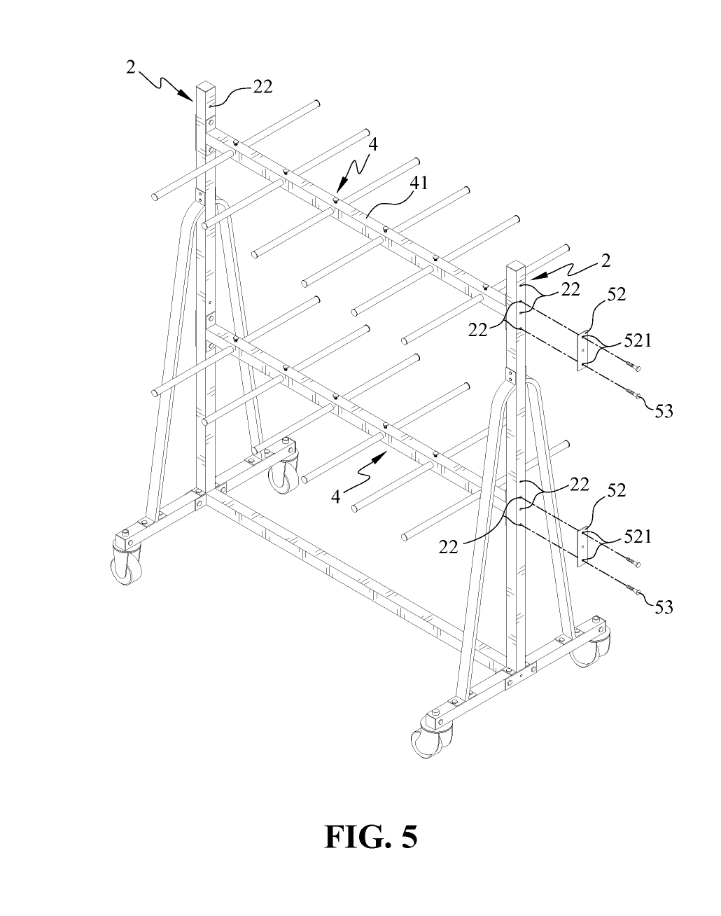

FIG. 4A is an exploded view showing the cross beam and the hanging bars of the hanging rack according to an embodiment of the present invention. FIG. 4B is an exploded view showing the hanging bars and the protective caps according to an embodiment of the present invention. FIG. 4C is a cross sectional view showing the hanging bars being secured to the cross beam by screw bolts according to an embodiment of the present invention. FIG. 5 is an exploded view showing the standing poles and the hanging racks according to an embodiment of the present invention.

Referring to FIG. 5 and further referring to FIGS. 4A through 4C, it can be seen that the disassemblable folding chair hanging cart can be provided with a plurality of hanging racks 4. However, the exact quantity of hanging racks 4 provided is mostly determined in accordance with the specific height of the standing poles 2. In the embodiments shown in the foregoing drawings, it is exemplified that there are two hanging racks 4 provided. As shown in FIG. 4A, each hanging rack includes a cross beam 41, and a plurality of hanging bars 42. The cross beam 41 has two opposite ends. One end of the cross beam 41 is adapted for being connected to one standing pole 2, and another end of the cross beam 41 is adapted for being connected to the other standing pole 2. The cross beam 41 is configured with a plurality of horizontal through holes 411 horizontally and transversely extending through the cross beam 41, and a plurality of vertical through holes 412 vertically and transversely extending through an upper wall of the cross beam 41. Preferably, the inner wall of each of the vertical through holes 412 is taped with inner threads. The hanging bars 42 are configured in a hollow round tube shape. Each of the hanging bars 42 is configured with an opening 421 at a central position thereof. The hanging bars 42 are allowed to be inserted through the horizontal through holes 411 of the cross beam 41, such that the openings 421 of the hanging bars 42 are aligned with the vertical through holes 412 of the cross beam 41. Preferably, the vertical through holes 412 are taped with inner threads thereby. In such a way, as shown in FIG. 4C, a plurality of threaded bolts 43 are inserted though and threadly matched with the vertical through holes 412, and are further inserted though the openings 421 of the hanging bars 42, such that front ends of the threaded bolts 43 interfere with inner walls of the hanging bars 42, so as to apply pressing forces thereto. In such a way, the hanging bars 42 are fastened in position.

In accordance with a preferred embodiment of the present invention, both ends of each hanging bars 42 are provided with protective pads 44. The protective pads 44 are made of elastic or flexible materials, such as rubber. The protective pads 44 are adapted for protecting the user from being injured by the rigid end sides of the hanging bars 42. Further, the surface of each protective pad 44 is preferably configured with a protruded pattern 441 for providing further protection to the protective pad 123 itself.

Further, as shown in FIGS. 4B and 5, each hanging rack 4 is secured to the two standing poles 2 by fastener units 5. The fastener unit 5 includes two side wing plates 51, a rectangular plate member 52, and two screw sets 53. The cross beam 41 has two opposite end sides, and each of the two opposite end sides of the cross beam 41 is connected to one of the two standing poles 2 by such a fastener unit 5. The two side wing plates 51 of the fastener unit 5 are perpendicularly welded to the end side of the cross beam 41. Each of the two side wing plates 51 is configured with a through hole 511. Corresponding to the through holes 511 of the two side wing plates 51, the standing poles 2 to be connected to the end side is also configured with an assembly portion 22. The assembly portion 22 includes at least two through holes transversely configured through the standing poles 2. Preferably, the inner walls of the through holes of the assembly portions 22 are taped to configure inner threads thereby. Further, the rectangular plate member 52 is configured with two through holes 521 respectively corresponding to the through holes 511 of the two side wing plates 51. Each of the screw sets 53 includes a threaded bolt and a threaded nut. The threaded bolts of the screw sets 53 are adapted for sequentially passing through the through holes 521 of the rectangular plate members 52, passing through the through holes of the assembly portions 22 while matching with the inner threads configured at the inner walls thereof, and then passing through the through holes 511 of the side wing plates 51, and finally being locked with the threaded nuts of the screw sets 53. In such a way, a hanging rack 4 can be conveniently secured between two standing poles 2. However, it should be noted that the quantity of the hanging racks is not restricted by the present invention, and also the quantity of the assembly portions 22 is not restricted by the present invention. For example, alternative assembly portions 22 may be configured adjacent to the original assembly portions 22 for allowing adaptive adjustment of the height of the hanging rack 4 according to the height of the folding chairs.

Further, it is worth mentioning that the parts of the disassemblable folding chair hanging cart are exemplified as but not restricted to be assembled or connected by fastener units 5 as illustrated above. Any other approach adapted for convenient assemble and disassemble operation can be used. Furthermore, the quantities of the through holes and threaded bolts employed for the fastener units are not restricted by the present invention.

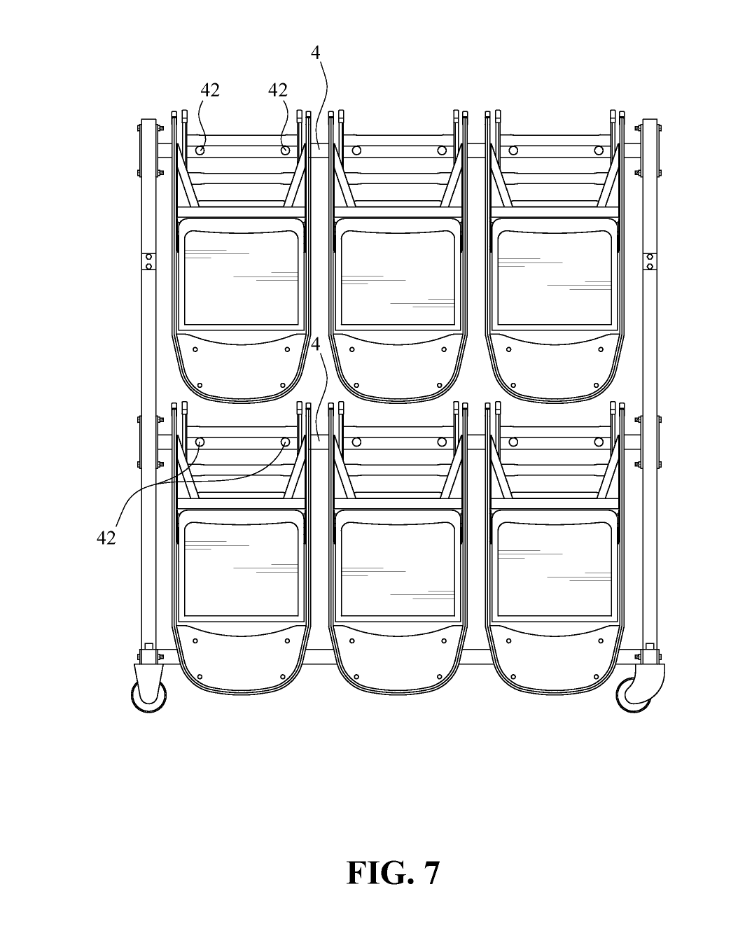

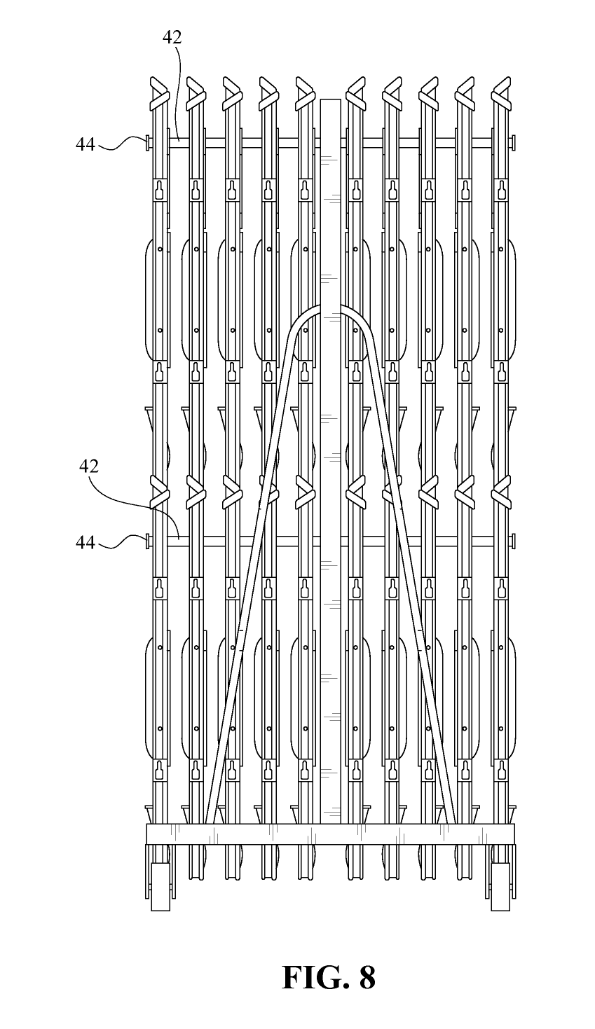

FIG. 7 illustrates the operation status of the disassemblable folding chair hanging cart, in which a plurality of folding chairs are accommodated on the disassemblable folding chair hanging cart. FIG. 8 is a side view of operation status of FIG. 7. Referring to FIGS. 7 and 8, in this embodiment, the present invention is illustrated as including two hanging racks 4. Both sides of the hanging bars 42 of the hanging racks 4 can be used for hanging folding chairs. In operation, according to the size of the folding chairs to be hung, two or three immediately adjacent hanging bars 42 are used for hanging one folding chair. In such a way, the disassemblable folding chair hanging cart can be used for carrying and delivering a plurality of folding chairs at the same time. As shown in FIGS. 7 and 8, the protective pads 44 provided at the ends of the hanging bars 42 are configured with protruded edges, which are adapted for stopping the folding chairs loaded thereby from falling off from the disassemblable folding chair hanging cart.

Although the present invention has been described with reference to the preferred embodiments thereof, it is apparent to those skilled in the art that a variety of modifications and changes may be made without departing from the scope of the present invention which is intended to be defined by the appended claims.

1. A disassemblable folding chair hanging cart, comprising:
a chassis;
a plurality of caster sets distributed in different positions of the chassis for providing a stable support for the disassemblable folding chair hanging cart;
two standing poles, vertically and symmetrically erected on opposite positions of the chassis, wherein each of the two standing poles being configured with a plurality of assembly portions, each assembly portion of a first of the two standing poles corresponding to one of the assembly portions of a second of the two standing poles, and the assembly portions of each standing pole are located at different heights and positions;
two reinforcement sets, wherein each reinforcement set is provided between one of the two standing poles and the chassis for reinforcing the connection strength therebetween; and
a plurality of hanging racks, each hanging rack including a cross beam having a plurality of holes, and a plurality of hanging bars, each cross beam having two opposite ends, and each of the hanging bars crossover the cross beam through one of the plurality of holes and is perpendicular to the cross beam, and the opposite ends of each cross beam are secured at corresponding assembly portions of the standing poles, so that the cross beams are positioned on the standing poles at different heights, both ends of each hanging bar being configured for hanging one or more folding chairs.

2. The disassemblable folding chair hanging cart as claimed in claim 1, wherein each caster set comprises a swivel-axle extending through the chassis and being perpendicular to the chassis, and a threaded bolt is provided for horizontally extending through the chassis and the swivel-axle to secure the caster set to the chassis.

3. The disassemblable folding chair hanging cart as claimed in claim 1, wherein each standing pole is secured to the chassis by a fastener unit.

4. The disassemblable folding chair hanging cart as claimed in claim 1, wherein each of the cross beams is secured to the standing poles by fastener units.

5. The disassemblable folding chair hanging cart as claimed in claim 1, wherein each reinforcement set is secured to the corresponding standing pole by a fastener unit, and each reinforcement set is secured to the chassis by an additional fastener unit.

6. The disassemblable folding chair hanging cart as claimed in claim 5, wherein each reinforcement set comprises two reinforcement rods symmetrically distributed at both sides of the standing pole, wherein the two reinforcement rods are secured to the standing pole and the chassis by fastener units, and the two reinforcement rods of the reinforcement set obliquely pull the standing pole toward two opposite sides of the chassis for providing a reinforcement of the strength of the connection therebetween.

7. The disassemblable folding chair hanging cart as claimed in claim 1, wherein the plurality of holes of each cross beam extend horizontally through the cross beam.

8. The disassemblable folding chair hanging cart as claimed in claim 7, wherein each cross beam includes a plurality of vertical holes, and each hanging bar includes a vertical hole that is aligned with one of the vertical holes of the hanging bar.

9. The disassemblable folding chair hanging cart as claimed in claim 8, wherein a bolt is inserted through the vertical hole of each hanging bar and the corresponding vertical hole of the cross beam such that an end of the bolt interferes with an inner wall of the hanging bar to apply a force thereto and keep the hanging bar in a fastened position.

10. The disassemblable folding chair hanging cart as claimed in claim 9, wherein an inner wall of each vertical hole of each cross beam is threaded, and each bolt is threaded to match the threads of the inner wall of the corresponding vertical hole.

11. The disassemblable folding chair hanging cart as claimed in claim 1, wherein each end of each hanging bar includes a protective pad to protect a user from being injured by the end of the hanging bar, each protective pad having a protruding pattern configured to stop a folding chair loaded on the hanging bar from falling off from the disassemblable folding chair hanging cart.

12. The disassemblable folding char hanging cart as claimed in claim 1, wherein each cross beam is secured at the corresponding assembly portion by a side wing plate having a through hole and formed at the end of the cross beam, a rectangular plate member having a through hole and placed on an opposite side of the vertical pole from the side wing plate, and a screw that extends through both through holes and the vertical standing pole to secure the cross beam.
